(19) United States
(12) Patent Application Publication
(10) Pub. No.: US 2007/0082158 A1
(43) Pub. Date: Apr. 12, 2007

(54) Composite film bag for packaging bulk products

(75) Inventor: Michael R. Nowak, Hilbert, WI (US)

Correspondence Address: DUANE MORRIS, LLP;IP DEPARTMENT, 30 SOUTH 17TH STREET, PHILADELPHIA, PA, 19103-4196, US

(73) Assignee: Coating Excellence International

(21) Appl. No.: 11/244,691

(22) Filed: Oct. 6, 2005

(51) Int. Cl. B60R 21/16

(52) U.S. Cl. 428/36.1

(57) ABSTRACT

A composite bag suitable for packaging bulk products, including, but not limited to, bulk food items, pet food, grains and cereals, seeds, fertilizers, and other bulk articles.

### FIELD OF THE INVENTION

The present invention relates to a composite bag suitable for packaging bulk products, including, but not limited to, bulk food items, pet food, grains and cereals, seeds, fertilizers, and other bulk articles.

### BACKGROUND OF THE INVENTION

The conventional bag used domestically to package bulk products, such as dog food, cereals, seeds, fertilizers, e.g., is made of multiple layers of paper and solid plastic films. The outer ply typically comprises a poly-coated paper with a smooth printing surface. The paper may be laminated to a layer of film and another paper layer. One downfall of the domestic bags used for bulk products is the cost of incorporating several composite layers of film and paper to achieve adequate strength.

In overseas markets, these bags are often made without paper, and comprise a middle layer of woven mesh material to which a pre-printed plastic film is adhered. The woven mesh material typically comprises sheets of polypropylene film that are cut into narrow strips and then woven together to form a woven mesh or net-like material. Some imported bags are comprised of mesh tubes made out of polypropylene, to which solid polypropylene film is adhered. Others are comprised of polypropylene mesh or net-like sheets that are adhered to a sheet of solid polypropylene and formed on bagging equipment to incorporate a side seam. The layer of film provides a smooth surface for printing graphics. The pre-printed film is made of polypropylene, as is the woven mesh to which it is adhered. The bags are sewn, stapled, laced, or stitched shut on the top and bottom.

A downfall of the mesh/film polypropylene bags used overseas is that the outer film layer is too smooth and slippery, causing problems on packaging equipment and in warehousing the bagged product. Because of the slipperiness of the outer film layer, the bags do not stack well and slide when stacked, stored, and/or transported on pallets or on warehouse shelves. The slickness of the film may be also cause problems on high-speed packaging equipment.

Both the domestic and overseas markets demand a composite bag with excellent printability and adequate strength for storing bulk products. These bags must also prevent slippage during manufacturing, transporting, and storing. The domestic and world markets also demand that these bags be comprised of cost-effective materials that meet the strength and performance needs of the marketplace. A cost-effective bag also would be comprised of materials that can easily and readily be adapted to high-speed bag equipment.

### SUMMARY OF THE INVENTION

The present invention relates to a multi-layered composite bag used to store bulk type products like pet food, seeds, fertilizer, cereals, grains and other bulk products intended for human and non-human consumption. The present invention improves both the structure and performance of the prior art bags and is more cost-effective than using a paper/plastic structure. The present invention provides a bag comprising a middle layer of woven mesh tubing to which an outer layer of solid plastic film is adhered using polypropylene or some other poly laminate.

It is an object of the present invention for the outside layer of film (comprising the outside of the bag) to be printed or reverse-printed with graphics and product labeling. An object of the present invention is to incorporate the use of cost-effective solid films that provide excellent printability and strength and meet performance standards required by the marketplace.

It is an object of the present invention to incorporate the use of films that are treated or coated to prevent slippage of bags during manufacturing, packaging, transport, and storage. It is an object of the present invention for the materials to partially or wholly comprise compostable, degradable, or recyclable materials. The present invention also incorporates the use of alternative films and woven mesh materials that are cost effective, provide adequate strength, and deliver better performance results.

It is an object of the present invention for the bag to comprise a woven mesh material formed into a tube to which a sheet of plastic film is adhered using a lamination process. The mesh material is comprised of suitable film-forming plastic resin that is split and/or stretched and then woven to form a mesh or net-like material. The woven mesh material is formed into a tubular shape to easily adapt to high-speed bag-forming equipment. The tube, which is flattened and gusseted, is then fed into a laminator with two extruders, and laminated on both sides of the flattened tube to a solid plastic film using polypropylene or other poly laminate.

Among the alternative films that can be employed in making the mesh tubes are, without limitation, thermoplastic synthetic polymers, including polyolefins such as low density polyethylene, linear low density polyethylene, polypropylene coated with a layer of polyethylene, high density polyethylene, metallocene, electron-beam cured solid films, copolymers of ethylene and propylene and combinations of these polymers, polyesters, polyamides, polyvinyl polymers, and copolymers, and PLA resins. Preferred resins are polyethylene, low density, high density, or linear low density, and combinations thereof, as well as polypropylene coated or laminated with a layer of polyethylene, and polyesters. An object of the present invention is to provide strength, integrity, and support for the bag structure through the use of materials that provide improved performance.

The solid plastic film to which the mesh tubes are adhered are comprised of various thermoplastic resins or polymers or combinations thereof, including but not limited to, low density polyethylene, high density polyethylene, linear low density polyethylene, metallocene, and/or polypropylene coated with a layer of polyethylene, films coated with electron-beam surfaces that may or may not be pre-printed, and PLA resins.

An object of the present invention is for the bag to comprise an outer solid plastic film layer that is printed or reverse-printed with graphics and/or product labeling and then adhered to the mesh tubes using adhesives, poly extrusion laminating, or some other known means of attaching the two layers. The mesh tube comprises the inside layer of the bag, giving the package strength and integrity. A layer of transparent or colored film may also serve as an inside liner of the bag and may or may not be printed. The outside film layer also is treated or otherwise coated on one side with any material that alters the level of slipperiness or tackiness of the outer surface, including the static coefficient of friction measure, making the bags less likely to slip during manufacturing, transporting or storing.

It is an object of the present invention to also include various methods of sealing and shutting the bags on the top and bottom, including but not limited to sewing, stitching, stapling, using adhesives or heat seals to close the top and bottom of the bag, using a zip-lock technology for resealing, or inserting a tear-strip in one end of the bag for easy opening.

It is an object of the present invention for the bag's outer and/or inner layers of film to be comprised of polypropylene coated or laminated with polyethylene.

It is an object of the present invention for the bag to be made of a woven mesh material and film layers comprising a polyethylene, polyester, polypropylene, or other polymer resin to which a degradable additive is added, typically in pellet form, during extrusion or other manufacturing process.

It is an object of the present invention for the bag to comprise a woven mesh comprising PLA resin. The layer of solid plastic film may also comprise a PLA resin.

It is an object of the present invention for the bag to comprise a solid plastic film layer that may be printed and then coated or covered with an electron-beam curable material. The EB-cured side of the bag comprises the outer surface of the bag.

### BRIEF DESCRIPTION OF THE DRAWING

FIG. 1 is a depiction of a side view of the composite layers comprising the present invention.

### DETAILED DESCRIPTION OF THE DRAWING

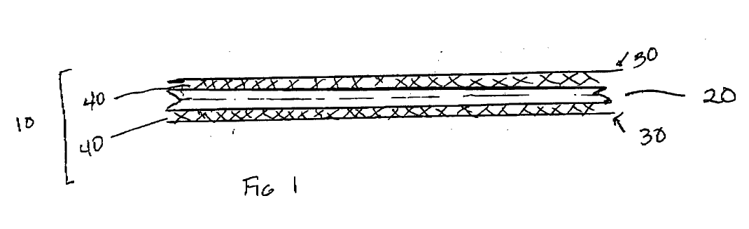

FIG. 1 shows a side view of the present invention comprising a composite bag (10) that is made from a woven mesh tube (20) that is flattened and gusseted. The woven mesh tube (20) provides the integrity and strength of the composite bag (10) and is comprised of thermoplastic synthetic polymers, including but not limited to, low density polyethylene, linear low density polyethylene, high density polyethylene, polypropylene coated with a layer of polyethylene, metallocene, electron-beam-cured solid films, polyesters, and PLA resins, or thermoplastic polymers to which a degradable or compostable additive is added, among other synthetic polymers.

The mesh tube (20) is fed into a laminator with two extruders and is laminated using a poly laminate (40) to adhere a layer of solid plastic film (30) to both sides of the flattened and gusseted bag (10). The film layers (30) are comprised of thermoplastic synthetic resins, including but not limited to, low, linear low, or high density polyethylene, polypropylene coated with a layer of polyethylene, metallocene, electron-beam-cured film, polyester, PLA resins, or thermoplastic polymers to which a degradable or compostable additive is added. The film layers (30) are either printed or reverse-printed using a flexographic or other printing method.

1. A composite bag used for packaging or storing bulk products comprising:
a woven mesh tube that is gusseted and flattened;
a layer of poly laminate on both sides of said gusseted and flattened tube; and
a layer of solid plastic film adhered to both sides of said gusseted, flattened tube.

2. The composite bag of claim 1 wherein said woven mesh tube comprises a film-forming plastic resin that is split and/or stretched and woven to form a woven mesh material.

3. The composite bag of claim 1 wherein said mesh material is formed into a tube comprising, thermoplastic polymers, including polyolefins such as low density polyethylene, linear low density polyethylene, polypropylene coated with a layer of polyethylene, high density polyethylene, metallocene, PLA resin, copolymers of ethylene and/or propylene, and/or combinations of these polymers, polyesters, polyamides, polyvinyl polymers, and copolymers, or films treated or coated with an EB-curable layer, or plastic films to which a degradable or compostable additive is added.

4. The composite bag of claim 1 wherein said solid plastic film comprises thermoplastic resins or polymers or combinations thereof, including but not limited to, low density polyethylene, high density polyethylene, linear low density polyethylene, metallocene, polyester, polypropylene coated with polyethylene, or any combination thereof, or PLA resins.

5. The composite bag of claim 1 wherein an additive is added during extrusion of the solid plastic film layer rendering the material compostable, degradable, and/or recyclable in whole or part.

6. The composite bag of claim 1 wherein said woven mesh comprises a plastic resin to which an additive is added that renders material compostable, degradable, and/or recyclable.

7. The composite bag of claim 1 wherein said laminate comprises polypropylene, polyethylene, polyester, or some other polymer resin or combination thereof.

8. The composite bag of claim 1 wherein said mesh or net-like material and/or the solid film layers are comprised of PLA resin.

9. The composite bag of claim 1 wherein said solid plastic film is printed or reverse-printed using flexographic, roto gravure, or some other printing method.

10. The composite bag of claim 1 in which outside layer of said solid film layer is treated or coated so as to adjust slipperiness or tackiness of said outer layer of said bag.

11. The composite bag of claim 1 in which outer solid film layer is printed and coated with an electron-beam-curable material or varnish.

12. The composite bag of claim 1 comprising a bag that closed on top and bottom by sewing, stitching, lacing, gluing, stapling, or use of adhesives, zip-lock technology, tear strips, or heat sealing, or some other means of adhering said tops and bottoms.

13. The method of producing said composite bag of claim 1 wherein said woven mesh tube is gusseted and flattened and laminated on both sides of said flattened bag to a solid plastic film using a poly laminar with two extruders.

14. The composite bag of claim 1 wherein said bag is used to package bulk food items, pet food, grains and cereals, seeds, fertilizers and other bulk articles.
